(19) United States
(12) Patent Application Publication
(10) Pub. No.: US 2024/0161087 A1
(43) Pub. Date: May 16, 2024

(54) CONTACTLESS PAYMENT VIA MOBILE DEVICES USING HYBRID COMMUNICATIONS APPROACH

(71) Applicant: A.C.N. 602 586 952 PTY LTD, QUEENSCLIFF (AU)

(72) Inventor: Matthew WARD, QUEENSCLIFF (AU)

(73) Assignee: A.C.N. 602 586 952 PTY LTD, QUEENSCLIFF, NS (AU)

(21) Appl. No.: 18/552,192

(22) PCT Filed: Mar. 23, 2022
(86) PCT No.: PCT/AU2022/050259

§ 371 Date: Sep. 25, 2023

(30) Foreign Application Priority Data
Mar. 24, 2021 (AU) 2021900876

(51) Int. Cl. G06Q 20/32; G06Q 20/40

(52) U.S. Cl. CPC G06Q 20/3278; G06Q 20/325; G06Q 20/40145; G06Q 20/4018

(57) ABSTRACT

The present invention relates, in various embodiments, to contactless payment technology, whereby contactless payments are made via mobile devices using hybrid communications approach (for example using Near Field Communications and a secondary wireless communications technology). Embodiments of the invention are primarily directed to enabling contactless payments without needing to utilise NFC transmission functionalities via the mobile device.

### FIELD OF THE INVENTION

The present invention relates, in various embodiments, to contactless payment technology, whereby contactless payments are made via mobile devices using hybrid communications approach (for example using Near Field Communications and a secondary wireless communications technology). Embodiments of the invention are primarily directed to enabling contactless payments without needing to utilise NFC transmission functionalities via the mobile device. While some embodiments will be described herein with particular reference to those applications, it will be appreciated that the invention is not limited to such a field of use, and is applicable in broader contexts.

### BACKGROUND OF THE INVENTION

Any discussion of the background art throughout the specification should in no way be considered as an admission that such art is widely known or forms part of common general knowledge in the field.

Contactless payments via smartphones and other mobile devices have become popular and widespread in modern society. In overview, a mobile device with an appropriately configured NFC chip is configured to transmit, to a Point of Sale (POS) system, a set of secure data which allows for completion of a financial transaction.

It is known for manufacturers of mobile device hardware and/or operating system software to “lock down” NEC transmission functions, thereby preventing third party software applications from making full use of an available NEC chipset, including completing contactless payments via common NFC-enabled POS hardware. For example, many popular smartphone models are presently configured to enable contactless payment via NEC via manufacturer-approved (e.g. factory installed) software, but prevented from making contactless payments via NEC using third party apps, given restrictions which prevent such third party apps from accessing transmission functions of a NEC chipset.

### SUMMARY OF THE INVENTION

It is an object of the present invention to overcome or ameliorate at least one of the disadvantages of the prior art, or to provide a useful alternative.

One embodiment provides a method for facilitating a contactless payment via a mobile device between: a networked payment terminal which is configured to receive payment information from a mobile device in a contactless manner via Near Field Communications (NFC) technology; and a mobile device having an NFC chipset, and a further wireless communications interface; the method including:
(i) receiving a primary payment signal from the mobile device, wherein the primary signal is transmitted by the mobile device via the further wireless communications interface;
(ii) processing the primary payment signal, thereby to define a secondary payment signal, wherein the secondary payment signal is configured to be transmitted to the networked payment terminal via NFC, thereby to provide to the networked payment terminal with information required to take further processing steps in relation to an in-progress payment transaction;
(iii) transmitting the secondary payment signal to the networked payment terminal via NFC, thereby to trigger a process in the networked payment terminal which includes taking the further processing steps in relation to the in-progress payment transaction.

One embodiment provides a method wherein the primary signal is received from the mobile device in response to the mobile device receiving a signal, via NFC, from the networked payment terminal.

One embodiment provides a method wherein the primary signal is defined by the mobile device only after successful biometric authentication of an authorised user of the mobile device.

One embodiment provides a method wherein the primary payment signal includes data representative of an authentication token.

One embodiment provides a method wherein the primary payment signal includes data representative of an authentication token in the form of a Device Account Number (DAN) which uniquely is: (i) unique to the mobile device; and (ii) reconcilable by a remote system to a defined payment account identifier.

One embodiment provides a method wherein the primary payment signal includes data representative of one or more of: (i) a dynamic cryptogram; (ii) a Device Account Number (DAN), (iii) a Dynamic Card Verification Value (CVV).

One embodiment provides a method wherein the primary signal is a Bluetooth signal, and wherein the further wireless communications interface is a Bluetooth interface.

One embodiment provides a method wherein the primary signal is a WiFi signal, and wherein the further wireless communications interface is a WiFi interface.

One embodiment provides a method wherein the networked payment terminal is an EMV-compliant payment terminal.

One embodiment provides a method wherein processing the primary payment signal, thereby to define a secondary payment signal includes performing a secure data conversion operation.

One embodiment provides a transaction enabling device for facilitating a contactless payment via a mobile device between: a networked payment terminal which is configured to receive payment information from a mobile device in a contactless manner via Near Field Communications (NFC) technology; and a mobile device having an NFC chipset, and a further wireless communications interface;
the transaction enabling device including:
(i) a first wireless communications interface configured to receive a primary payment signal from the mobile device, wherein the primary signal is transmitted by the mobile device via the further wireless communications interface;
(ii) a microprocessor which is configured to process the primary payment signal, thereby to define a secondary payment signal, wherein the secondary payment signal is configured to be transmitted to the networked payment terminal via NFC, thereby to provide to the networked payment terminal with information required to take further processing steps in relation to an in-progress payment transaction;
(iii) a NFC chipset which is configured to transmit the secondary payment signal to the networked payment terminal via NFC, thereby to trigger a process in the networked payment terminal which includes taking the further processing steps in relation to the in-progress payment transaction.

One embodiment provides a transaction enabling device wherein the primary signal is received from the mobile device in response to the mobile device receiving a signal, via NFC, from the networked payment terminal.

One embodiment provides a transaction enabling device wherein the primary signal is defined by the mobile device only after successful biometric authentication of an authorised user of the mobile device.

One embodiment provides a transaction enabling device wherein the primary payment signal includes data representative of an authentication token.

One embodiment provides a transaction enabling device wherein the primary payment signal includes data representative of an authentication token in the form of a Device Account Number (DAN) which uniquely is: (i) unique to the mobile device; and (ii) reconcilable by a remote system to a defined payment account identifier.

One embodiment provides a transaction enabling device wherein the primary payment signal includes data representative of one or more of: (i) a dynamic cryptogram; (ii) a Device Account Number (DAN); (iii) a Dynamic Card Verification Value (CVV)

One embodiment provides a transaction enabling device wherein the primary signal is a Bluetooth signal, and wherein the further wireless communications interface is a Bluetooth interface.

One embodiment provides a transaction enabling device wherein the primary signal is a WiFi signal, and wherein the further wireless communications interface is a WiFi interface.

One embodiment provides a transaction enabling device wherein the networked payment terminal is an EMV-compliant payment terminal.

One embodiment provides a transaction enabling device wherein processing the primary payment signal, thereby to define a secondary payment signal includes performing a secure data conversion operation.

One embodiment provides a POS terminal device for facilitating a contactless payment via a mobile device, the a mobile device having an NFC chipset, and a further wireless communications interface, the POS terminal including:
(i) a NFC chipset which is configured to transmit and receive data via NFC,
(ii) a wireless communications interface configured to receive a primary payment signal from the mobile device, wherein the primary signal is transmitted by the mobile device via the further wireless communications interface;
(iii) a microprocessor which is configured to process the primary payment signal, thereby to define a secondary payment signal, wherein the secondary payment signal is configured to provide to the networked payment terminal with information required to take further processing steps in relation to an in-progress payment transaction, such that the networked payment terminal in response performs a process including taking the further processing steps in relation to the in-progress payment transaction.

One embodiment provides a POS terminal device for wherein the primary signal is received from the mobile device in response to the mobile device receiving a signal, via NFC, from the networked payment terminal.

One embodiment provides a POS terminal device for wherein the primary signal is defined by the mobile device only after successful biometric authentication of an authorised user of the mobile device.

One embodiment provides a POS terminal device for wherein the primary payment signal includes data representative of an authentication token.

One embodiment provides a POS terminal device for wherein the primary payment signal includes data representative of an authentication token in the form of a Device Account Number (DAN) which uniquely is: (i) unique to the mobile device; and (ii) reconcilable by a remote system to a defined payment account identifier.

One embodiment provides a POS terminal device for wherein the primary payment signal includes data representative of one or more of: (i) a dynamic cryptogram; (ii) a Device Account Number (DAN); (iii) a Dynamic Card Verification Value (CVV)

One embodiment provides a POS terminal device for wherein the primary signal is a Bluetooth signal, and wherein the further wireless communications interface is a Bluetooth interface.

One embodiment provides a POS terminal device for wherein the primary signal is a WiFi signal, and wherein the further wireless communications interface is a WiFi interface.

One embodiment provides a POS terminal device for wherein the networked payment terminal is an BMV-compliant payment terminal.

One embodiment provides a POS terminal device for wherein processing the primary payment signal, thereby to define a secondary payment signal includes performing a secure data conversion operation.

Further example embodiments are described below in the section entitled “claims”.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

### BRIEF DESCRIPTION OF DRAWINGS

Embodiments of the invention will now be described, by way of example only, with reference to the accompanying drawings in which:

FIG. 1A illustrates a technology framework according to one embodiment.

FIG. 1B illustrates a technology framework according to one embodiment,

FIG. 10 illustrates a technology framework according to one embodiment.

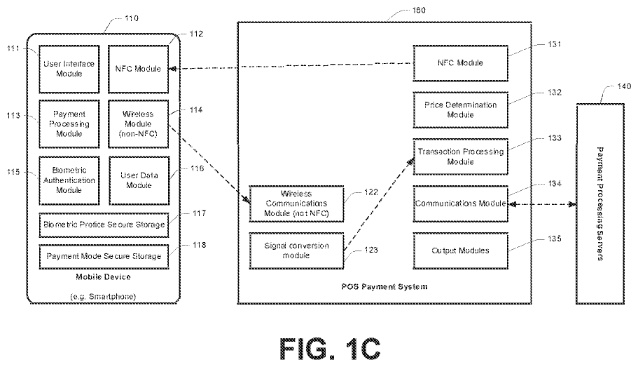

### DETAILED DESCRIPTION

The present invention relates, in various embodiments, to contactless payment technology, whereby contactless payments are made via mobile devices using hybrid communications approach (for example using Near Field Communications and a secondary wireless communications technology). Embodiments of the invention are primarily directed to enabling contactless payments without needing to utilise NFC transmission functionalities via the mobile device.

Examples are described below by reference to a mobile device in the form of a smartphone (for example a smartphone using an IOS or Android operating system). However, it will be appreciated that embodiments may be implemented via a wide range of mobile device, provided the necessary hardware components are available.

One embodiment provides a method for facilitating a contactless payment via a mobile device between:
a networked payment terminal (e.g. a POS terminal) which is configured to receive payment information from a mobile device in a contactless manner via Near Field Communications (NFC) technology (for example, this may be an EMV compliant POS terminal); and
a mobile device having an NFC chipset, and a further wireless communications interface (for example a smartphone, smartwatch or the like, having an NFC chipset and a further wireless communications interface such as Bluetooth or WiFi).

The method may be performed in some embodiments via a standalone device, which is in a preferred embodiment a portable device which is configured to be positioned adjacent to the POS terminal, or more preferably mounted to the POS terminal. In other embodiments the standalone device is functionally incorporated into a POS terminal. The method includes:
(i) Receiving a primary payment signal from the mobile device, wherein the primary signal is transmitted by the mobile device via the further wireless communications interface. For example, the primary signal may be communicated via Bluetooth or WiFi. The primary signal is provided in response to a user instruction at the mobile device, which preferably requires biometric authentication of the user. In some embodiments, the user is prompted to provide that instruction in response to a trigger event, wherein the trigger event includes reading a predefined NFC signal at the mobile device.
(ii) Processing the primary payment signal, thereby to define a secondary payment signal, wherein the secondary payment signal is configured to be transmitted to the networked payment terminal via NFC, thereby to provide to the networked payment terminal with information required to take further processing steps in relation to an in-progress payment transaction. In an example embodiment, the primary signal contains information which allows this processing to define a secondary signal which includes all or a subset of the following: a Device Account Number (DAN) which uniquely is: (i) unique to the mobile device; and (ii) reconcilable by a remote system to a defined payment account identifier; a dynamic cryptogram; and a Dynamic Card Verification Value (CVV). In another example embodiment the primary signal contains an alternate collection of data configured to enable the processing of a payment transaction by the payment terminal.
(iii) Transmitting the secondary payment signal to the networked payment terminal via NFC, thereby to trigger a process in the networked payment terminal which includes taking the further processing steps in relation to the in-progress payment transaction. In some embodiments, transmission “via NFC” includes transmission of data in an NFC encoding format via an alternate transmission means.

Via this approach, the POS terminal operates as though it is performing a conventional NFC-based contactless payment transaction. However, in the context of the mobile device, this is performed without the mobile device needing to access transmit functionality of its NFC chipset, instead communicating via a wireless protocol such as Bluetooth or WiFi. The device responsible for performing the method above in effect acts as a translating intermediary, providing NFC transmission functions which may be otherwise unavailable via the mobile device. This allows for contactless payment transactions to be performed via third party software applications executing on the mobile device, without a need for the mobile device to transmit data via NFC.

As context, an example conventional contactless mobile device transaction involved the following steps:
A user authentication process (for example including biometric authentication) is performed by the mobile device.
In the case that the authentication process is successful, the mobile device is enabled to access and transmit payment related information. For example, this may include a dynamic cryptogram, DAN, and Dynamic CVV. This may be encrypted.
The payment related information is transmitted via NFC communication.
The NFC communication is received via an NFC chipset of a POS terminal.
The POS terminal transmits the dynamic cryptogram, DAN, and Dynamic CVV to a server associated with a merchant bank, typically in combination with additional transaction information (e.g. a transaction value).
The merchant bank transmits the dynamic cryptogram, DAN, and Dynamic CVV to a payment network (again, typically in combination with additional transaction information such as transaction value). For example, the payment network may be associated with a particular brand of payment card.
The payment network interacts with a card issuer, thereby to perform decryption, verify funds are available, and validate/authorise a transaction.
Where validation/authorisation of the transaction is successful, that information is passed back downstream to the POS terminal (and in some cases to the mobile device).

It will be appreciated that, in practice, this hinges on an ability of the mobile device to transmit custom information via NFC. This is not always possible. For example, some mobile devices lack NFC custom transmission capabilities. Furthermore, some mobile devices prevent third party apps from accessing NFC custom transmission capabilities.

Technology disclosed herein provides a means by which a mobile device is able to partake in a relatively conventional contactless payment transaction with an NFC enabled POS terminal (e.g. EMV compliant) without needing to transmit data via NFC. Instead, the mobile device communicates via an alternate wireless communications medium, for example with an intermediary device, which defines an appropriate NFC signal for transmission to the POS terminal.

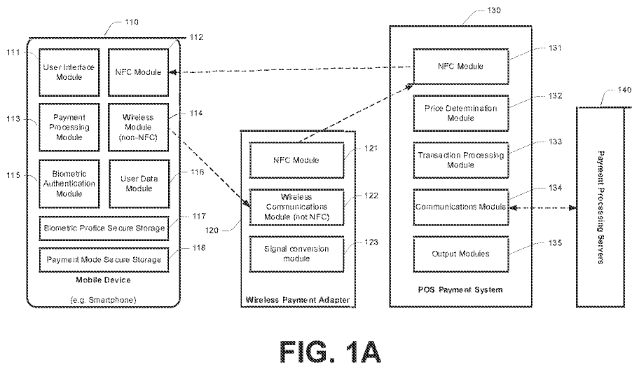

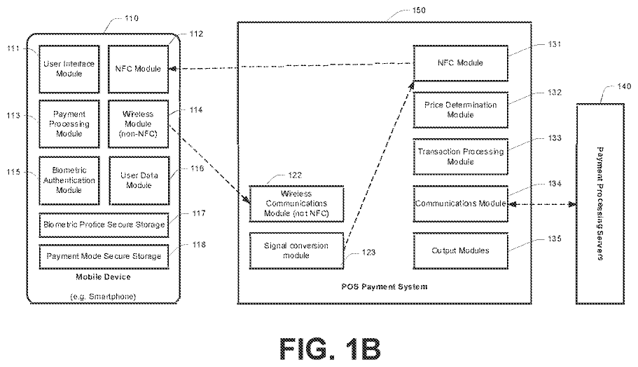

FIG. 1A illustrates a technology framework according to one embodiment. It should be appreciated that, although the framework of FIG. 1 utilises elements of known hardware, software, communication techniques and processing techniques, the manner by which these and other elements are combined allows the delivery of improved data integrity management processes which deliver technical improvements over conventional/intrinsic smartphone technology. That is, the combination of the hardware and the software, together with the results of operating the system, produce new and previously unknown outcomes. These new and previously unknown outcomes deliver technical advantages in the field of data security and integrity management. These outcomes find useful application across a wide range of commercial fields.

Software executing at the mobile device and other devices in FIG. 1A is described by reference to a plurality or “modules”. The term “module” refers to a software component that is logically separable (a computer program), or a hardware component. The module of the embodiment refers to not only a module in the computer program but also a module in a hardware configuration. The discussion of the embodiment also serves as the discussion of computer programs for causing the modules to function (including a program that causes a computer to execute each step, a program that causes the computer to function as means, and a program that causes the computer to implement each function), and as the discussion of a system and a method. For convenience of explanation, the phrases “stores information,” “causes information to be stored,” and other phrases equivalent thereto are used. If the embodiment is a computer program, these phrases are intended to express “causes a memory device to store information” or “controls a memory device to cause the memory device to store information,” The modules may correspond to the functions in a one-to-one correspondence. In a software implementation, one module may form one program or multiple modules may form one program. One module may form multiple programs. Multiple modules may be executed by a single computer. A single module may be executed by multiple computers in a distributed environment or a parallel environment. One module may include another module. In the discussion that follows, the term “connection” refers to not only a physical connection but also a logical connection (such as an exchange of data, instructions, and data reference relationship). The term “predetermined” means that something is decided in advance of a process of interest. The term “predetermined” is thus intended to refer to something that is decided in advance of a process of interest in the embodiment. Even after a process in the embodiment has started, the term “predetermined” refers to something that is decided in advance of a process of interest depending on a condition or a status of the embodiment at the present point of time or depending on a condition or status heretofore continuing down to the present point of time. If “predetermined values” are plural, the predetermined values may be different from each other, or two or more of the predetermined values (including all the values) may be equal to each other. A statement that “if A, B is to be performed” is intended to mean “that it is determined whether something is A, and that if something is determined as A, an action B is to be carried out”. The statement becomes meaningless if the determination as to whether something is A is not performed.

The term “system” refers to an arrangement where multiple computers, hardware configurations, and devices are interconnected via a communication network (including a one-to-one communication connection). The term “system”, and the term “device”, also refer to an arrangement that includes a single computer, a hardware configuration, and a device. The system does not include a social system that is a social “arrangement” formulated by humans.

At each process performed by a module, or at one of the processes performed by a module, information as a process target is read from a memory device, the information is then processed, and the process results are written onto the memory device. A description related to the reading of the information from the memory device prior to the process and the writing of the processed information onto the memory device subsequent to the process may be omitted as appropriate. The memory devices may include a hard disk, a random-access memory (RAM), an external storage medium, a memory device connected via a communication network, and a ledger within a CPU (Central Processing Unit).

It will be appreciated that devices illustrated in FIG. 1A are illustrated omitting various conventional hardware components, for example microprocessors and memory modules. For the sake of clear illustration, only functionally critical components/modules are illustrated.

FIG. 1A illustrates three main separate computing environments:
A mobile device 110, which may for example be a smartphone (or alternately a smartwatch or the like). For the sake of this example, the mobile device is described as being configured to execute a “Payment Application”, which is a software application stored on the mobile device and configured to execute on the mobile device.
A POS payment system 130. This could be any generic POS payment system which is configured to handle contactless NFC transactions, for example an EMV compliant POS terminal.
Payment system processing servers 140. This is intended to represent a collection of back-end networked infrastructure which authorises (or refuses to authorise) a payment transaction based on a request by POS system 130. Detailed operation of the processing servers is well understood in the art, and generally superfluous to the present disclosure. All that is crucial is that POS system 130 is configured to provide data in a format needed for the purposes of servers 140, and able to receive an authorisation signal from servers 140.
A wireless payment adapter 120. This is preferably a low-power device, for example a battery powered device which is able to be located/mounted on or adjacent POS system 130 (within NFC communication range), As discussed below, adapter 120 provides a translation bridge between a non-NFC signal provided by mobile device 101, and a NFC signal transmitted to POS system 130.

Mobile device 110 includes a NFC module 112, which is configured to receive a signal from NFC module 131 of POS system 130. In some embodiments, NFC module 131 is configured to transmit a NFC signal which triggers the mobile device to launch the Payment Application. In other embodiments this does not occur, and a user manually launches the Payments Application when the user wishes to make a payment.

When the user launches the Payments Application (e.g. in response to a NFC-based trigger), a graphical user interface for the Payments Application is rendered via user interface module 111. In some embodiments accessing functions of the Payments Application requires the user to successful pass a biometric authentication process via a biometric authentication module 115 and biometric profile secure storage 117. This may optionally leverage a biometric authentication process native to the device operating system. In further embodiments user authorisation/authentication is performed via means other than biometric.

In some embodiments the user interface of the Payments Application allows a user to select between multiple payment cards, for example based on information stored by a user data module 116. This preferably excludes details such as full payment card numbers, instead providing limited information which allows a user to identify a desired card without having all information required to complete a transaction presented on-screen.

After optionally selecting between multiple payment cards, the user provides a “submit payment command”. This in some cases triggers the biometric authentication process. In the case that the submit payment command is authorised, a payment processing module 113 defines data for transmission via a wireless module 114, which may be a Bluetooth module (or in other embodiments WiFi). This includes accessing from a secure storage location 118 information to enable the defining of a transmission data packet containing data representative of some or all of the following: a Device Account Number (DAN) which uniquely is: (i) unique to the mobile device; and (ii) reconcilable by a remote system to a defined payment account identifier; a dynamic cryptogram; and a Dynamic Card Verification Value (CVV).

Where the transmission data packet is communicated via Bluetooth, this is optionally communicated as encrypted frames which are readable and decryptable by a communications module 122 and signal conversion module 123 of adapter 120. Preferably module 122 has a wireless radio tuned allowing for receipt of Bluetooth transmissions occurring only within a short range (for example less than 1 m, or less than 0.5 m).

Conversion module 123 is configured to process the transmission data from the mobile device, and convert that into an EMV compliant NFC transmission, which is then transmitted by NCF module 121 to NFC module 131, thereby to enable POS system 130 to authorise a transaction in substantially the same manner as if the NFC signal were communicated by an EMV compliant smartphone.

In some embodiments the transmission data communicated to adapter 120 contains employee information, and completing information required to collate an EMV compliant DAN, dynamic cryptogram, and dynamic CVV is supplied via operation of module 123 (for example using a token stored by adapter 120). This assists in overcoming potential security issues associated with Bluetooth.

Upon receiving the EMV compliant NFC transmission, POS system 130 operates a transaction processing module to authorise a transaction. This, in the present example, includes determining a transaction amount from a price determination module (which may optionally receive a signal from a user interface device or a connected sales system), and providing data to servers 140 via a communications module 134. In the event that the transaction is authorised by servers 140, POS system 130 provides an output via output modules 135 (for example a display screen).

In the alternate examples if FIG. 1B an FIG. 1C, various functions of adapter 120 are integrated into POS systems 150 and 160. In particular:
In the example of FIG. 18, POS payment system 122 includes a wireless communications module 122 which operates on a protocol other than NFC, which is configured to receive data from module 112 of device 110. Module 122 operates in conjunction with a signal conversion module 123, thereby to translate data received via module 122 into a form suitable for NFC module 131, thereby to functionally mimic receipt of data via module 131 as would occur in a scenario where a mobile device provided payment information via NFC. Module 123 may communicate with module 131 via NFC, or via a physical wired connection.
The example of FIG. 1C is similar to that of FIG. 18, except that signal conversion module shortcuts NFC module 131 and communicates directly with transaction processing module 133. In this manner, module 123 is configured to provide a proxy of an output that would otherwise be provided by module 131 in the context of a NFC payment transaction. Accordingly, module 133 is able to process a transaction in a similar manner regardless of whether payment information is received via module 131 or module 122 (via module 123).

Other variations beyond those illustrated in FIG. 18 and FIG. 1C are possible within the context of the present disclosure,

It will be appreciated that the technology disclosed above provides useful improvements in the context of contact payment transaction processing.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment, Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

What is claimed is:

1. A method for facilitating a contactless payment via a mobile device between:
a networked payment terminal which is configured to receive payment information from a mobile device in a contactless manner via Near Field Communications (NTC) technology; and
a mobile device having an NEC chipset, and a further wireless communications interface;
the method including:
(i) receiving a primary payment signal from the mobile device, wherein the primary signal is transmitted by the mobile device via the further wireless communications interface;
(ii) processing the primary payment signal, thereby to define a secondary payment signal, wherein the secondary payment signal is configured to be transmitted to the networked payment terminal via NEC, thereby to provide to the networked payment terminal with information required to take further processing steps in relation to an in-progress payment transaction;
(iii) transmitting the secondary payment signal to the networked payment terminal via NFC, thereby to trigger a process in the networked payment terminal which includes taking the further processing steps in relation to the in-progress payment transaction.

2. The method according to claim 1 wherein the primary signal is received from the mobile device in response to the mobile device receiving a signal, via NFC, from the networked payment terminal.

3. The method according to claim 1 wherein the primary signal is defined by the mobile device only after successful biometric authentication of an authorized user of the mobile device.

4. The method according to claim 1 wherein the primary payment signal includes data representative of an authentication token.

5. The method according to claim 1 wherein the primary payment signal includes data representative of an authentication token in the form of a Device Account Number (DAN) which uniquely is: (i) unique to the mobile device; and (ii) reconcilable by a remote system to a defined payment account identifier.

6. The method according to claim 1 wherein the primary payment signal includes data representative of one or more of: (i) a dynamic cryptogram; (ii) a Device Account Number (DAN); (iii) a Dynamic Card Verification Value (CVV).

7. The method according to claim 1 wherein the primary signal is a Bluetooth signal, and wherein the further wireless communications interface is a Bluetooth interface.

8. The method according to claim 1 wherein the primary signal is a WiFi signal, and wherein the further wireless communications interface is a WiFi interface.

9. The method according to claim 1 wherein the networked payment terminal is an EMV-compliant payment terminal.

10. The method according to claim 1, wherein processing the primary payment signal, thereby to define a secondary payment signal includes performing a secure data conversion operation.

11. A transaction enabling device for facilitating a contactless payment via a mobile device between:
a networked payment terminal which is configured to receive payment information from a mobile device in a contactless manner via Near Field Communications (NFC) technology; and
a mobile device having an NFC chipset, and a further wireless communications interface;
the transaction enabling device including:
(i) a first wireless communications interface configured to receive a primary payment signal from the mobile device, wherein the primary signal is transmitted by the mobile device via the further wireless communications interface;
(ii) a microprocessor which is configured to process the primary payment signal, thereby to define a secondary payment signal, wherein the secondary payment signal is configured to be transmitted to the networked payment terminal via NEC, thereby to provide to the networked payment terminal with information required to take further processing steps in relation to an in-progress payment transaction;
(iii) a NFC chipset which is configured to transmit the secondary payment signal to the networked payment terminal via NEC, thereby to trigger a process in the networked payment terminal which includes taking the further processing steps in relation to the in-progress payment transaction.

12. The transaction enabling device according to claim 11 wherein the primary signal is received from the mobile device in response to the mobile device receiving a signal, via NEC, from the networked payment terminal.

13. The transaction enabling device according to claim 11 wherein the primary signal is defined by the mobile device only after successful biometric authentication of an authorised user of the mobile device.

14. The transaction enabling device according to claim 11 wherein the primary payment signal includes data representative of an authentication token.

15. The transaction enabling device according to claim 11 wherein the primary payment signal includes data representative of an authentication token in the form of a Device Account Number (DAN) which uniquely is: (i) unique to the mobile device; and (ii) reconcilable by a remote system to a defined payment account identifier.

16. The transaction enabling device according to claim 11 wherein the primary payment signal includes data representative of one or more of: (i) a dynamic cryptogram; (ii) Device Account Number (DAN); (iii) a Dynamic Card Verification Value (CVV).

17. The transaction enabling device according to claim 11 wherein the primary signal is a Bluetooth signal, and wherein the further wireless communications interface is a Bluetooth interface.

18. The transaction enabling device according to claim 11 wherein the primary signal is a WiFi signal, and wherein the further wireless communications interface is a WiFi interface.

19. The method according to claim 11 wherein the networked payment terminal is an EMV-compliant payment terminal.

20. The transaction enabling device enabling device according to claim 11 wherein processing the primary payment signal, thereby to define a secondary payment signal includes performing a secure data conversion operation.

21. A POS terminal device for facilitating a contactless payment via a mobile device, a mobile device having an NEC chipset, and a further wireless communications interface;
the POS terminal including:
(i) a NEC chipset which is configured to transmit and receive data via NFC;
(ii) a wireless communications interface configured to receive a primary payment signal from the mobile device, wherein the primary signal is transmitted by the mobile device via the further wireless communications interface;
(iii) a microprocessor which is configured to process the primary payment signal, thereby to define a secondary payment signal, wherein the secondary payment signal is configured to provide to the networked payment terminal with information required to take further processing steps in relation to an in-progress payment transaction, such that the networked payment terminal in response performs a process including taking the further processing steps in relation to the in-progress payment transaction.

22. The POS terminal device according to claim 21 wherein the primary signal is received from the mobile device in response to the mobile device receiving a signal, via NFC, from the networked payment terminal.

23. The POS terminal device according to claim 21 wherein the primary signal is defined by the mobile device only after successful biometric authentication of an authorised user of the mobile device.

24. The POS terminal device according to claim 21 wherein the primary payment signal includes data representative of an authentication token.

25. The POS terminal device according to claim 21 wherein the primary payment signal includes data representative of an authentication token in the form of a Device Account Number (DAN) which uniquely is: (i) unique to the mobile device; and (ii) reconcilable by a remote system to a defined payment account identifier.

26. The POS terminal device according to claim 21 wherein the primary payment signal includes data representative of one or more of: (i) a dynamic cryptogram; (ii) a Device Account Number (DAN); (iii) a Dynamic Card Verification Value (CVV).

27. The POS terminal device according to claim 21 wherein the primary signal is a Bluetooth signal, and wherein the further wireless communications interface is a Bluetooth interface.

28. The POS terminal device according to claim 21 wherein the primary signal is a WiFi signal, and wherein the further wireless communications interface is a WiFi interface.

29. The POS terminal device according to claim 21 wherein the networked payment terminal is an EMV-compliant payment terminal.

30. The POS terminal device according to claim 21 wherein processing the primary payment signal, thereby to define a secondary payment signal includes performing a secure data conversion operation.
